(19) United States
(12) Patent Application Publication
(10) Pub. No.: US 2026/0309141 A1
(43) Pub. Date: Oct. 8, 2026

(54) RECIPROCATING COMPRESSOR

(71) Applicant: LG ELECTRONICS INC., Seoul (KR)

(72) Inventors: Younghwan KIM, Seoul (KR); Youngboo SON, Seoul (KR); Seokjong JANG, Seoul (KR)

(21) Appl. No.: 18/875,356

(22) PCT Filed: Jul. 27, 2022
(86) PCT No.: PCT/KR2022/011027

§ 371 Date: Dec. 16, 2024

(30) Foreign Application Priority Data
Jun. 21, 2022 (KR) 10-2022-0075593

(51) Int. Cl. F04B 39/00; F04B 35/04; F04B 39/12

(52) U.S. Cl. CPC F04B 39/0061; F04B 39/123

(57) ABSTRACT

A reciprocating compressor according to an embodiment of the present disclosure includes a suction/discharge unit that suctions a refrigerant, supplies the refrigerant to a compression unit, and discharges the refrigerant compressed by the compression unit. The suction/discharge unit includes a suction muffler and a discharge muffler. The discharge muffler includes a plurality of discharge muffler members that are spaced apart from each other, and adjacent discharge muffler members among the plurality of discharge muffler members are connected by a discharge hose. The reciprocating compressor can reduce a size (or volume) of the discharge muffler member which is positioned adjacent to the suction muffler among the plurality of discharge muffler members, can form discharge muffler members as much as the reduced size (volume) at another location, and can increase a size (or volume) of the suction muffler as much as a reduction in the size (or volume) of the discharge muffler member positioned adjacent to the suction muffler.

### TECHNICAL FIELD

The present disclosure relates to a reciprocating compressor, and more particularly, to a reciprocating compressor including multiple discharge mufflers.

### BACKGROUND ART

In general, a hermetic compressor is a compressor that includes a motor generating power inside of a hermetic container and a compression unit that operates by receiving the power of the motor.

The hermetic compressor may be classified into a reciprocating compressor, a rotary compressor, a vane compressor, a scroll compressor, or the like, based on a method of compressing a refrigerant which is a compressible fluid.

The reciprocating compressor is configured such that a crankshaft is coupled to a rotor of a motor, a connecting rod is coupled to the crankshaft, and a piston coupled to the connecting rod compresses a refrigerant while linearly reciprocating inside a cylinder.

The reciprocating compressor includes a hermetic container forming a sealed space, a motor that is provided in the hermetic container and performs a rotational motion, a compression unit that is installed on an upper side of the motor and receives a rotational force of the motor to compress a refrigerant, a suction unit that suctions the refrigerant and supplies the refrigerant to the compression unit, and a discharge unit that discharges the refrigerant compressed by the compression unit.

The suction unit includes a suction pipe fixed to the hermetic container, and a suction muffler that supplies the refrigerant suctioned from the suction pipe to the compression unit. The discharge unit includes a discharge pipe fixed to the hermetic container, a discharge muffler for reducing a discharge noise of the discharged refrigerant, and a discharge hose connecting the discharge muffler and the discharge pipe.

In the reciprocating compressor with the above-described configuration, the suction muffler and the discharge muffler must each have a volume greater than or equal to a predetermined size. However, as the size of the compressor decreases, the volumes occupied by the suction muffler and the discharge muffler in the total volume inside the hermetic container increase.

Here, the “volume” indicates a volume of an internal space of the muffler filled with the refrigerant and/or discharge gas.

Therefore, when intending to (micro)miniaturize the compressor, the size (or volume) of the suction muffler and the discharge muffler need to be reduced as much as the decrease in the size of the compressor.

Here, a micro-compressor refers to a compressor in which at least one of the width, depth, and height is 110 mm or less based on the size of the hermetic container.

However, when the height of the compressor is reduced by 9 mm to (micro)miniaturize the compressor, heights of the suction muffler and the discharge muffler are each reduced by 6 mm. That is, the volume of the suction muffler and the volume of the discharge muffler are reduced to approximately 85% of the volume before the height of the compressor is reduced.

Accordingly, there is a problem that a cooling capacity of the compressor is reduced due to the volume reduction of the suction muffler, and the performance of the compressor is reduced by approximately 2%, and there is a problem that a discharge pulsation increases due to the volume reduction of the discharge muffler.

If the compressor is operated at a high speed of 85 rps or higher to prevent a cooling capacity of the micro-compressor from deteriorating, there is a problem that the discharge pulsation further increases.

Since the existing reciprocating compressor includes only one discharge muffler, there is a problem that pulsation noise of various frequencies cannot be effectively reduced.

### DISCLOSURE

### Technical Problem The present disclosure is to solve the above-described problems.

A technical object of the present disclosure is to provide a reciprocating compressor that is microminiaturized without reducing a volume of a suction muffler and a volume of a discharge muffler.

Another technical object of the present disclosure is to provide a reciprocating compressor that is microminiaturized while preventing a cooling capacity from deteriorating.

Another technical object of the present disclosure is to provide a reciprocating compressor that is microminiaturized while efficiently reducing discharge pulsation.

Another technical object of the present disclosure is to provide a reciprocating compressor that is microminiaturized while efficiently reducing pulsation noise with various frequencies.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

In one aspect of the present disclosure, there is provided a reciprocating compressor comprising a hermetic container forming a sealed space; a discharge pipe coupled to the hermetic container; a motor including a stator and a rotor, the motor being installed in the hermetic container to generate a rotational force; a compression unit including a connecting rod that converts the rotational force of the motor into a linear drive force, a piston connected to the connecting rod, and a cylinder into which the piston is movably inserted, the compression unit being configured to compress a refrigerant; and a suction/discharge unit including a suction muffler, a discharge muffler, and a suction/discharge tank including a suction space into which the refrigerant passing through the suction muffler is introduced and a discharge space into which the refrigerant compressed by the compression unit is introduced.

The discharge muffler includes a plurality of discharge muffler members including a main muffler that is positioned on an opposite side of the suction muffler with the suction/discharge tank in between, and a sub-muffler that is spaced apart from the main muffler and is connected to the main muffler by a discharge hose. The suction muffler includes an extension portion that extends from a lower side of the suction/discharge tank toward the main muffler.

According to the above-described configuration, the reciprocating compressor can reduce a size (or volume) of the main muffler which is positioned adjacent to the suction muffler among the plurality of discharge muffler members, can form discharge muffler members as much as the reduced size (volume) at another location, and can increase a size (or volume) of the suction muffler as much as a reduction in the size (or volume) of the main muffler positioned adjacent to the suction muffler.

Accordingly, the reciprocating compressor can be (micro)miniaturized without reducing the volumes of the suction muffler and the discharge muffler compared to the conventional one.

Even if an operating speed is increased to improve an insufficient cooling capacity due to the (micro)miniaturization of the reciprocating compressor, discharge pulsation can be effectively reduced, and thus a cooling capacity can be prevented from deteriorating.

In other words, the cooling capacity can be increased in proportion to the increase in the operating speed of the reciprocating compressor.

In addition, since various discharge muffler members can be formed along a discharge path of a discharge gas, an empty space of the hermetic container can be utilized to the maximum extent, and the plurality of discharge muffler members can be designed so as to reduce discharge pulsation noise of a specific frequency.

A volume of the main muffler may be greater than a volume of the sub-muffler.

According to the above-described configuration, the plurality of discharge muffler members can be designed so as to reduce discharge pulsation noise of a specific frequency.

The sub-muffler may include a first sub-muffler connected to the main muffler by the discharge hose and a second sub-muffler connected to the first sub-muffler by the discharge hose.

Volumes of the main muffler, the first sub-muffler, and the second sub-muffler can be variously formed so as to reduce discharge pulsation noise of a specific frequency.

For example, a volume of the main muffler may be greater than each of a volume of the first sub-muffler and a volume of the second sub-muffler, and the volume of the first sub-muffler may be greater than the volume of the second sub-muffler.

In this instance, the volume of the first sub-muffler may be less than or equal to 50% of the volume of the main muffler, and the volume of the second sub-muffler may be less than or equal to 50% of the volume of the first sub-muffler.

According to the above-described configuration, the discharge pulsation noise can be efficiently reduced.

At least one of the first sub-muffler and the second sub-muffler may be formed by extending a diameter of a portion of the discharge hose.

According to the above-described configuration, a manufacturing process and an assembly process of the sub-muffler can be reduced.

Each of the first sub-muffler and the second sub-muffler may be formed in a cylindrical shape.

According to the above-described configuration, an installation space for the sub-muffler can be easily secured.

The second sub-muffler may be directly coupled to the discharge pipe.

According to the above-described configuration, the number of discharge hoses can be reduced.

At least two sub-mufflers may further include a third sub-muffler positioned between the main muffler and the first sub-muffler.

According to the above-described configuration, the discharge pulsation noise can be more efficiently reduced.

The third sub-muffler may be positioned adjacent to the extension portion of the suction muffler at a lower side of the main muffler, connected to the main muffler by the discharge hose, and connected to the first sub-muffler by the discharge hose.

Accordingly, an installation space for the third sub-muffler can be easily secured.

A width of the third sub-muffler may be less than a width of the main muffler.

According to the above-described configuration, the discharge pulsation noise can be more efficiently reduced.

The volume of the main muffler may be greater than a volume of the third sub-muffler, and the volume of the third sub-muffler may be greater than the volume of the first sub-muffler.

In this instance, the volume of the third sub-muffler may be less than or equal to 50% of the volume of the main muffler, the volume of the first sub-muffler may be less than or equal to 50% of the volume of the third sub-muffler, and the volume of the second sub-muffler may be less than or equal to 50% of the volume of the first sub-muffler.

According to the above-described configuration, the discharge pulsation noise can be more efficiently reduced.

### Advantageous Effects

A reciprocating compressor according to the present disclosure can reduce a size (or volume) of a main muffler which is positioned adjacent to a suction muffler with a suction/discharge tank interposed between the suction muffler and the main muffler among a plurality of discharge muffler members, can form discharge muffler members as much as the reduced size (volume) at another location, and can increase a size (or volume) of the suction muffler as much as a reduction in the size (or volume) of the main muffler positioned adjacent to the suction muffler.

Accordingly, the reciprocating compressor can be (micro)miniaturized without reducing the volumes of the suction muffler and the discharge muffler compared to the conventional one.

Even if an operating speed is increased to improve an insufficient cooling capacity due to the (micro)miniaturization of the reciprocating compressor, discharge pulsation can be effectively reduced, and thus a cooling capacity can be prevented from deteriorating.

In other words, the cooling capacity can be increased in proportion to the increase in the operating speed of the reciprocating compressor.

In addition, since various discharge muffler members can be formed along a discharge path of a discharge gas, an empty space of a hermetic container can be utilized to the maximum extent, and the plurality of discharge muffler members can be designed so as to reduce discharge pulsation noise of a specific frequency.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is an appearance perspective view of a reciprocating compressor according to an embodiment of the present disclosure.

FIG. 2 is an exploded perspective view of a reciprocating compressor according to an embodiment of the present disclosure.

FIG. 3 is a cross-sectional view of a reciprocating compressor according to an embodiment of the present disclosure.

FIG. 4 illustrates a partial configuration of a reciprocating compressor according to an embodiment of the present disclosure.

FIG. 5 is a front perspective view illustrating a connection of a muffler assembly and a discharge hose according to an embodiment of the present disclosure.

FIG. 6 is a rear perspective view illustrating a connection of a muffler assembly and a discharge hose according to an embodiment of the present disclosure.

FIG. 7 schematically illustrates a connection of the muffler assembly and the discharge hose illustrated in FIGS. 5 and 6.

FIG. 8 schematically illustrates a connection of a muffler assembly and a discharge hose according to another embodiment of the present disclosure.

FIG. 9 schematically illustrates a connection of a muffler assembly and a discharge hose according to another embodiment of the present disclosure.

FIG. 10 schematically illustrates a connection of a muffler assembly and a discharge hose according to another embodiment of the present disclosure.

FIG. 11 is a graph illustrating changes in an outlet pressure depending on the number of discharge muffler members of a reciprocating compressor.

FIG. 12 is a graph illustrating an improvement effect of discharge pulsation of a reciprocating compressor including a muffler assembly illustrated in FIG. 10.

FIG. 13 schematically illustrates a connection of a muffler assembly and a discharge hose according to another embodiment of the present disclosure.

### MODE FOR INVENTION

Reference will now be made in detail to embodiments of the present disclosure, examples of which are illustrated in the accompanying drawings. Wherever possible, the same reference numbers will be used throughout the drawings to refer to the same or like parts.

In general, a suffix such as “assembly” and “unit” may be used to refer to elements or components. Use of such a suffix herein is merely intended to facilitate description of the present disclosure, and the suffix itself is not intended to give any special meaning or function.

It will be noted that a detailed description of known arts will be omitted if it is determined that the detailed description of the known arts can obscure embodiments of the present disclosure.

The accompanying drawings are used to help easily understand various technical features and it should be understood that embodiments presented herein are not limited by the accompanying drawings. As such, the present disclosure should be understood to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being coupled to” or “being assembled with” other component, this should be understood to mean that another component may exist between them although any component may be directly coupled to or assembled with the other component.

On the other hand, when any component is described as “being directly coupled to” or “being assembled with” other component, this should be understood to mean that no component exists between them.

A singular expression can include a plural expression as long as it does not have an apparently different meaning in context.

In embodiments of the present disclosure, terms “include or comprise” or “have” should be understood to be intended to designate that illustrated features, numbers, steps, operations, components, parts or combinations thereof are present and not to preclude the existence of one or more other features, numbers, steps, operations, components, parts or combinations thereof, or the possibility of the addition thereof.

Reference will now be made in detail to embodiments of the present disclosure, examples of which are illustrated in the accompanying drawings. Wherever possible, the same reference numbers will be used throughout the drawings to refer to the same or like parts.

A reciprocating compressor according to embodiments of the present disclosure is described in detail below with reference to the accompanying drawings.

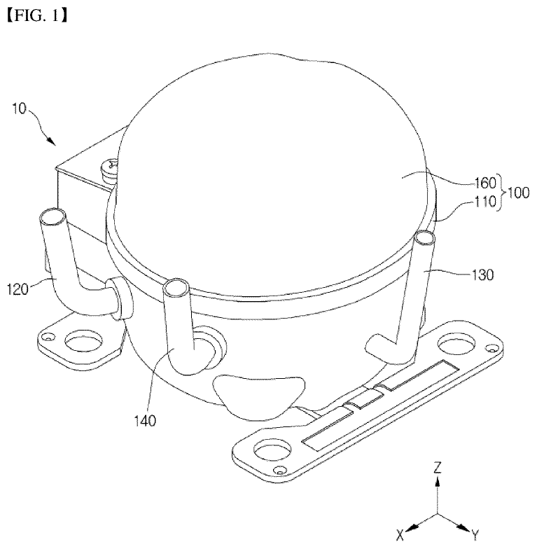

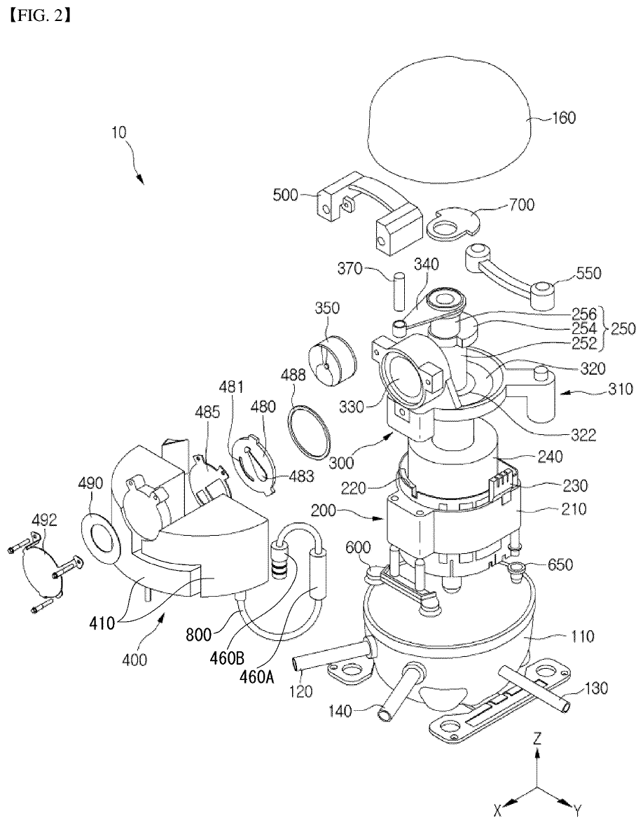

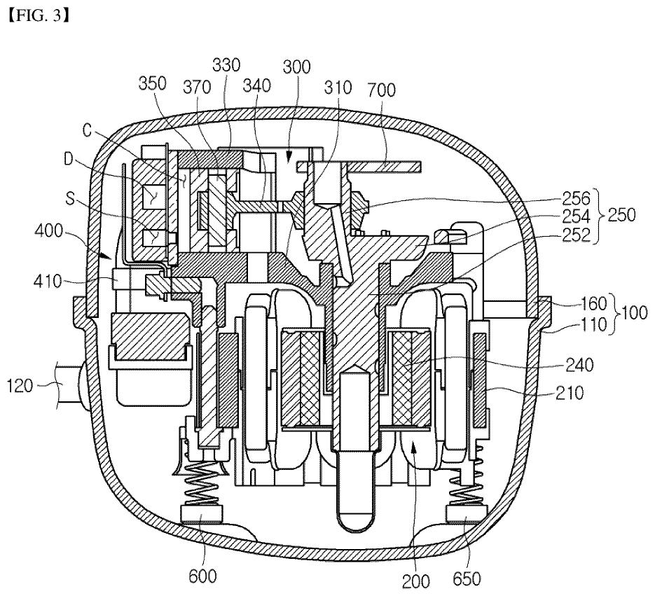

FIG. 1 is a perspective view of a reciprocating compressor according to an embodiment of the present disclosure. FIG. 2 is an exploded perspective view of a reciprocating compressor according to an embodiment of the present disclosure. FIG. 3 is a cross-sectional view of a reciprocating compressor according to an embodiment of the present disclosure.

Referring to FIGS. 1 to 3, a reciprocating compressor 10 according to an embodiment of the present disclosure includes a hermetic container 100 forming an appearance, a motor 200 that is located in an internal space of the hermetic container 100 and provides a drive force, a compression unit 300 that receives the drive force from the motor 200 and compresses a refrigerant through a linear reciprocating motion, and a suction/discharge unit 400 that suctions the refrigerant for refrigerant compression of the compression unit 300 and discharges the refrigerant compressed from the compression unit 300.

The hermetic container 100 forms a sealed space therein and accommodates various components of the compressor 10 in the sealed space. The hermetic container 100 is made of a metal material and includes a lower hermetic container 110 and an upper hermetic container 160.

The lower hermetic container 110 has a substantially hemispherical shape, and the lower hermetic container 110 and the upper hermetic container 160 form an accommodation space that accommodates various components forming the motor 200, the compression unit 300, the suction/discharge unit 400, and the compressor 10.

The lower hermetic container 110 may be referred to as a “compressor body”, and the upper hermetic container 160 may be referred to as a “compressor cover”.

The lower hermetic container 110 includes a suction pipe 120, a discharge pipe 130, a process pipe 140, and a power supply unit (not shown).

A refrigerant flows into the hermetic container 100 through the suction pipe 120, which is mounted to pass through the lower hermetic container 110.

The suction pipe 120 may be separately mounted on the lower hermetic container 110 or formed integrally with the lower hermetic container 110.

The discharge pipe 130 discharges the compressed refrigerant in the hermetic container 100 and is mounted to pass through the lower hermetic container 110.

The discharge pipe 130 may be separately mounted on the lower hermetic container 110 or formed integrally with the lower hermetic container 110.

A discharge hose 800 of the suction/discharge unit 400 described below is connected to the discharge pipe 130. The refrigerant flowing into the suction pipe 120 and compressed through the compression unit 300 may be discharged to the discharge pipe 130 via the discharge hose 800 of the suction/discharge unit 400.

The process pipe 140 is a device provided to charge a refrigerant into the hermetic container 100 after sealing the inside of the hermetic container 100. The process pipe 140 may be mounted to pass through the lower hermetic container 110 together with the suction pipe 120 and the discharge pipe 130.

The upper hermetic container 160 forms the accommodation space together with the lower hermetic container 110 and is formed in a substantially hemispherical shape like the lower hermetic container 110. The upper hermetic container 160 packages the lower hermetic container 110 on the lower hermetic container 110 to form the sealed space therein.

The motor 200 includes stators 210 and 220, an insulator 230, a rotor 240, and a rotational shaft 250.

The stators 210 and 220 are fixed components during the driving of the motor 200, and include a stator core 210 and a stator coil 220.

The stator core 210 may be made of a metal material and may have a substantially cylindrical shape with an inner hollow.

The stator coil 220 is mounted inside the stator core 210. When power is applied from the outside, the stator coil 220 generates an electromagnetic force to perform an electromagnetic interaction with the stator core 210 and the rotor 240. Through this, the motor 200 may generate the drive force for reciprocating motion of the compression unit 300.

The insulator 230 is located between the stator core 210 and the stator coil 220 and prevents a direct contact between the stator core 210 and the stator coil 220.

When the stator coil 220 is in direct contact with the stator core 210, as generation of the electromagnetic force from the stator coil 220 may be hindered, the insulator 230 prevents the direct contact.

The insulator 230 may separate the stator core 210 and the stator coil 220 by a predetermined distance from each other.

The rotor 240 may be rotatably provided inside the stator coil 220 and may be installed inside the insulator 230. The rotor 240 includes a magnet.

When the power is supplied from the outside, the rotor 240 rotates through the electromagnetic interaction with the stator core 210 and the stator coil 220.

A rotational force resulting from rotation of the rotor 240 acts as a drive force capable of driving the compression unit 200.

The rotational shaft 250 may be installed in the rotor 240, mounted to pass through the rotor 240 along an upward and downward direction, and rotate together with the rotor 240. The rotational shaft 250 is connected to a connecting rod 340 described below and transmits the rotational force generated from the rotor 240 to the compression unit 300.

The rotational shaft 250 includes a base shaft 252, a rotational plate 254, and an eccentric shaft 256.

The base shaft 252 is mounted in the rotor 240 in the upward and downward direction (Z-axis direction) or a longitudinal direction. When the rotor 240 rotates, the base shaft 252 may rotate together with the rotor 240.

The rotational plate 254 may be installed on one side of the base shaft 252 and may be rotatably mounted on a rotational plate seating part 320 of a cylinder block 310.

The eccentric shaft 256 protrudes upward from an upper surface of the rotational plate 254.

More specifically, the eccentric shaft 256 protrudes from the rotational plate 254 at an eccentric position from an axial center of the base shaft 252 and rotates eccentrically when the rotational plate 254 rotates.

The connecting rod 340 is mounted on the eccentric shaft 256. According to an eccentric rotation of the eccentric shaft 256, the connecting rod 340 linearly reciprocates in a forward and backward direction (X-axis direction).

The compression unit 300 includes the cylinder block 310, the connecting rod 340, a piston 350, and a piston pin 370.

The cylinder block 310 is provided on the motor 200, more specifically, on the rotor 240 and is mounted inside the hermetic container 100. The cylinder block 310 includes the rotational plate seating part 320 and a cylinder 330.

The rotational plate seating part 320 is formed at a bottom of the cylinder block 310 and rotatably accommodates the rotational plate 254. A shaft opening 322 through which the rotational shaft 250 passes is formed in the rotational plate seating part 320.

The cylinder 330 is provided at the front of the cylinder block 310 and accommodates the piston 350 described below. The piston 350 reciprocates in the forward and backward direction (X-axis direction), and a compression space C capable of compressing the refrigerant is formed inside the cylinder 330.

The cylinder 330 may be made of an aluminum material. For example, the cylinder 330 may be made of aluminum or aluminum alloy.

A magnetic flux generated from the rotor 240 is not transmitted to the cylinder 330 due to the aluminum material, which is non-magnetic. Hence, as the magnetic flux generated from the rotor 240 is not transmitted to the cylinder 330, the magnetic flux can be prevented from leaking outside of the cylinder 330.

The connecting rod 340 is a device that transmits the drive force provided from the motor 200 to the piston 350, and converts a rotational motion of the rotational shaft 250 into a linear reciprocating motion.

When the rotational shaft 250 rotates, the connecting rod 340 linearly reciprocates in the forward and backward direction (X-axis direction). The connecting rod 340 may be made of a sintered alloy material.

The piston 350 is a device that compresses the refrigerant. The piston 350 is accommodated in the cylinder 330 so as to be able to reciprocate in the forward and backward direction (X-axis direction). The piston 350 is connected to the connecting rod 340. The piston 350 linearly reciprocates in the cylinder 330 based on the movement of the connecting rod 340. As the piston 350 reciprocates, the refrigerant flowing from the suction pipe 120 may be compressed in the cylinder 330.

The piston 350 may be made of an aluminum material, for example, aluminum or an aluminum alloy in the same manner as the cylinder 330.

Therefore, the magnetic flux generated from the rotor 240 can be prevented from leaking to the outside through the piston 350.

In addition, the piston 350 may be made of the same material as the cylinder 330 and have substantially a same thermal expansion coefficient as the cylinder 330.

As the piston 350 and the cylinder 330 have substantially the same thermal expansion coefficient, when the compressor 10 is driven, the piston 350 is thermally deformed by substantially a same amount as the cylinder 330 in an internal environment of the hermetic container 100 at a high temperature (generally, about 100 °C). Therefore, when the piston 350 reciprocates in the cylinder 330, interference between the piston 350 and the cylinder 330 can be prevented from occurring.

The piston pin 370 couples the piston 350 to the connecting rod 340. That is, the piston pin 370 connects the piston 350 to the connecting rod 340 by penetrating the piston 350 and the connecting rod 340 in the upward and downward direction (Z-axis direction).

The suction/discharge unit 400 includes a muffler assembly 410, a valve assembly 480, discharge hose 800, a plurality of gaskets 485 and 488, an elastic member 490, and a clamp 492.

The muffler assembly 410 transfers the refrigerant suctioned from the suction pipe 120 to an inside of the cylinder 330, and the compressed refrigerant in the compression space C of the cylinder 330 is transferred to the discharge pipe 130.

That is, the muffler assembly 410 includes a suction space S that accommodates the refrigerant suctioned from the suction pipe 120, and a discharge space D that accommodates the compressed refrigerant in the compression space C of the cylinder 330.

The refrigerant suctioned from the suction pipe 120 is introduced into the suction space S of a suction/discharge tank 426 via suction mufflers 430 and 420 described below. The compressed refrigerant in the cylinder 330 passes through a discharge muffler described below via the discharge space D of the suction/discharge tank 426 and is discharged to the outside of the compressor 10 through the discharge hose 800.

The valve assembly 480 guides the refrigerant of the suction space S to the inside of the cylinder 330 or guides the compressed refrigerant in the cylinder 330 to the discharge space D.

That is, a discharge valve 483 is arranged on a front surface of the valve assembly 480 to open and close so that the compressed refrigerant in the compression space C is discharged to the discharge space D, and a suction valve 481 is arranged on a rear surface of the valve assembly 480 to open and close so that the refrigerant in the suction space S is discharged to the compression space C of the cylinder 330.

That is, the discharge valve 483 is provided on the front surface of the valve assembly 480, and the suction valve 481 is provided on the rear surface of the valve assembly 420.

Operation of the discharge valve 483 and the suction valve 481 is described below.

When the compressed refrigerant in the compression space C of the cylinder 330 is discharged, the discharge valve 483 is opened and the suction valve 481 is closed. Hence, the compressed refrigerant in the cylinder 330 may flow into the discharge space D without flowing into the suction space S.

Conversely, when the refrigerant flowing into the suction space S is suctioned into the cylinder 330, the discharge valve 483 is closed and the suction valve 481 is opened. Hence, the refrigerant in the suction space S may flow into the cylinder 330 without flowing into the discharge space D.

The discharge hose 800 is a device that transfers the compressed refrigerant accommodated in the discharge space D to the discharge pipe 130. The discharge hose 800 is coupled to the muffler assembly 410. A side of the discharge hose 800 is coupled to the muffler assembly 410 to communicate with the discharge space D, and another side of the discharge hose 800 is coupled to the discharge pipe 130.

The plurality of gaskets 485 and 488 are a device that prevents the refrigerant from leaking, and are mounted on a side and another side of the valve assembly 480, respectively.

Specifically, the plurality of gaskets 485 and 488 include a first gasket 485 and a second gasket 488. The first gasket 485 is mounted in front of the valve assembly 480, and the second gasket 488 is mounted in rear of the valve assembly 480.

The elastic member 490 supports the muffler assembly 410 when the compressor 10 is driven, and is mounted in front of the muffler assembly 410. The elastic member 490 may include a Belleville spring.

The clamp 492 fixes the valve assembly 480, the first gasket 485, the second gasket 488, and the elastic member 490 to the muffler assembly 410. The clamp 492 may be formed in a substantially triangular shape and mounted to the muffler assembly 410 through a fastening means, such as a screw member.

The compressor 10 further includes a plurality of damper members 500, 550, 600, and 650 and a balance weight 700.

The plurality of damper members 500, 550, 600, and 650 dampen vibration, etc. of internal structures generated when the compressor 10 is driven. The plurality of damper members 500, 550, 600, and 650 include a front damper 500, a rear damper 550, and lower dampers 600 and 650.

The front damper 500 dampens vibration of the suction/discharge unit 400 and may be made of a rubber material. The front damper 500 may be coupled to a front upper portion of the cylinder block 310 through a fastening means coupled to the clamp 492.

The rear damper 550 dampens vibration of the compression unit 300 and is mounted on a rear upper portion of the cylinder block 310. The rear damper 550 may be made of a rubber material.

The lower dampers 600 and 650 dampen vibration of the motor 200 and may include a plurality of dampers. For example, the plurality of lower dampers 600 and 650 may include a front lower damper 600 and a rear lower damper 650.

The front lower damper 600 dampens vibration on a front side of the motor 200 and is mounted on a front lower side of the stator core 210. The rear lower damper 650 dampens vibration on a rear side of the motor 200 and is mounted on a rear lower side of the stator core 210.

The balance weight 700 is a device that controls rotational vibration when the rotational shaft 250 of the motor 200 rotates. The balance weight 700 is coupled to the eccentric shaft 256 of the rotational shaft 250 at an upper side of the connecting rod 340.

Configurations of the muffler assembly 410 and the discharge hose 800 are described in detail below.

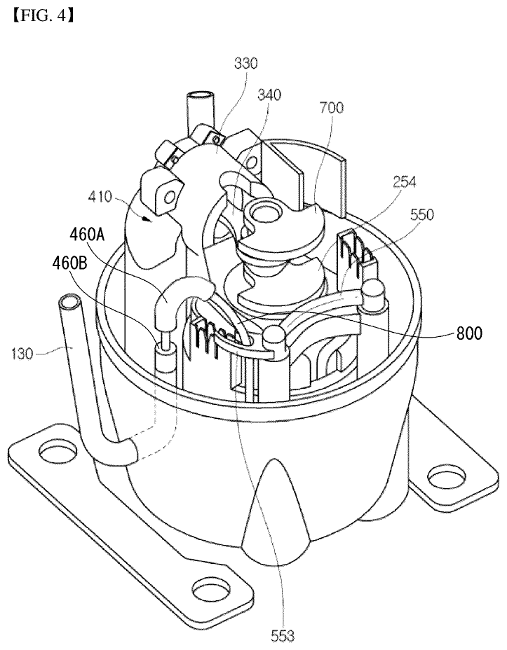

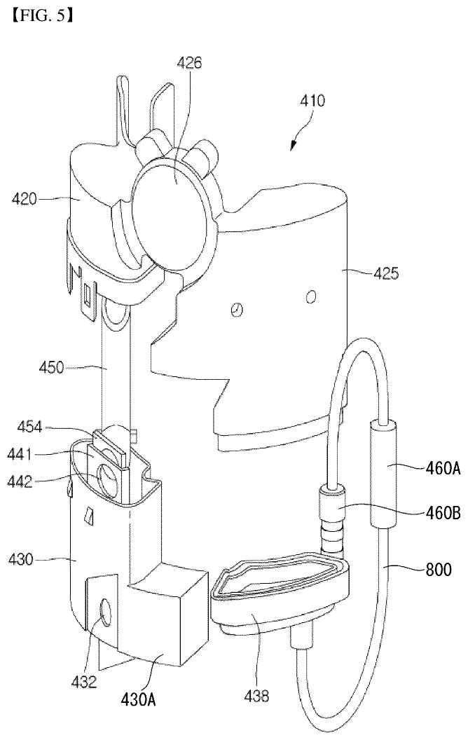

FIG. 4 illustrates a partial configuration of a reciprocating compressor according to an embodiment of the present disclosure. FIG. 5 is a front perspective view illustrating a connection of a muffler assembly and a discharge hose according to an embodiment of the present disclosure.

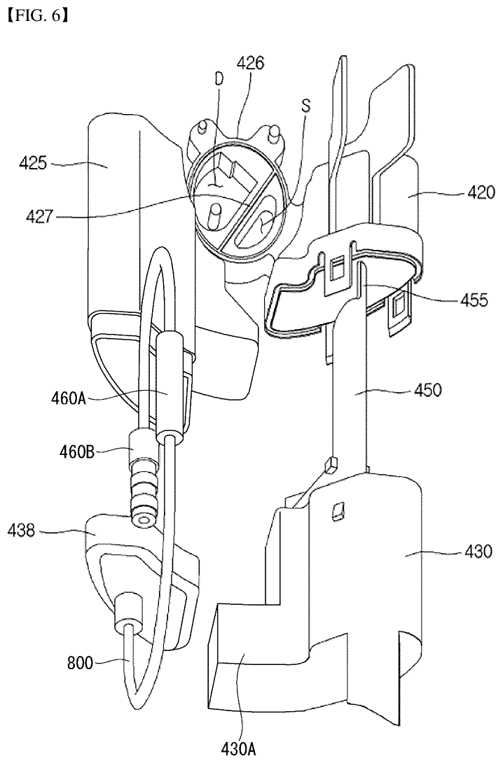

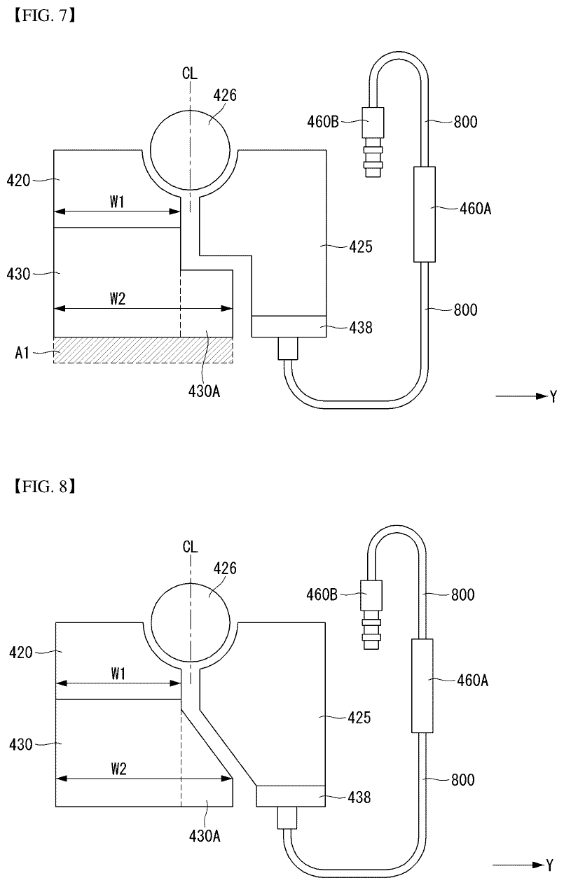

FIG. 6 is a rear perspective view illustrating a connection of a muffler assembly and a discharge hose according to an embodiment of the present disclosure. FIG. 7 schematically illustrates a connection of the muffler assembly and the discharge hose illustrated in FIGS. 5 and 6.

Before describing specific embodiments of the present disclosure, the features of the reciprocating compressor according to the present disclosure are briefly described. The reciprocating compressor according to the present disclosure includes a plurality of discharge muffler members, for example, three or more discharge muffler members, and the three or more discharge muffler members are connected in series or in parallel.

The reciprocating compressor with the above-described configuration can reduce a size (or volume) of a discharge muffler member, which is positioned adjacent to a suction muffler with a suction/discharge tank interposed between the suction muffler and the discharge muffler member, among a plurality of discharge muffler members, can form discharge muffler members as much as the reduced size (volume) at another location, and can increase a size (or volume) of the suction muffler as much as a reduction in the size (or volume) of the discharge muffler member positioned adjacent to the suction muffler.

Accordingly, the reciprocating compressor can be (micro)miniaturized without reducing the volumes of the suction muffler and the discharge muffler compared to the conventional one.

Even if an operating speed is increased to improve an insufficient cooling capacity due to the (micro)miniaturization of the reciprocating compressor, the discharge pulsation can be effectively reduced, and thus the cooling capacity can be prevented from deteriorating.

In other words, the cooling capacity can be increased in proportion to the increase in the operating speed of the reciprocating compressor.

In addition, since various discharge muffler members can be formed along a discharge path of a discharge gas, an empty space of the hermetic container can be utilized to the maximum extent, and a plurality of discharge muffler members can be designed so as to reduce discharge pulsation noise of a specific frequency.

The muffler assembly with various structures included in the reciprocating compressor according to the present disclosure is described below.

Referring to FIGS. 4 to 7, the muffler assembly 410 according to an embodiment of the present disclosure includes a first assembly part 430, a second assembly part 420, a third assembly part 425, and a fourth assembly part 438.

The first assembly part 430 includes a suction hole 432 that communicates with the suction pipe 120. The suction hole 432 is positioned adjacent to an inside of a point of the lower hermetic container 110 to which the suction pipe 120 is coupled. An inner pipe 450 is installed inside the first assembly part 430. For example, the inner pipe 450 may include a substantially cylindrical pipe.

A first fixing part 441 fixing the inner pipe 450 is installed inside the first assembly part 430. A through hole 442 corresponding to the suction hole 432 is formed in the first fixing part 441. Therefore, in a state in which the first fixing part 441 is installed inside the first assembly part 430, the suction hole 432 and the through hole 442 may be aligned with each other.

The inner pipe 450 includes a first coupling part 454 coupled to the first fixing part 441.

The inner pipe 450 may extend upward from the first assembly part 430 and may be coupled to the second assembly part 420. The second assembly part 420 includes a second fixing part coupled to the inner pipe 450. The inner pipe 450 includes a second coupling part 455 coupled to the second fixing part.

The second assembly part 420 is coupled to an upper side of the first assembly part 430. At least a portion of the inner pipe 450 may be positioned inside the first assembly part 430, and a remaining portion may be positioned inside the second assembly part 420.

When the first assembly part 430 and the second assembly part 420 are coupled, a suction passage through which the refrigerant suctioned into the compressor 10 flows toward the cylinder 330 is formed inside the first and second assembly parts 430 and 420. Thus, the first and second assembly parts 430 and 420 may be collectively referred to as a “suction muffler”.

The third assembly part 425 is spaced apart from one side of the second assembly part 420. The suction/discharge tank 426 that forms the suction space S and the discharge space D is installed between the second assembly part 420 and the third assembly part 425.

The suction/discharge tank 426 includes a partition 427 that partitions an internal space of the suction/discharge tank 426 into the suction space S and the discharge space D. The valve assembly 480 may be installed on or at one side of the suction/discharge tank 426.

The suction space S may be shielded by the suction valve 481, and the discharge space D may be shielded by the discharge valve 483.

The fourth assembly part 438 is coupled to a lower side of the third assembly part 425. When the third assembly part 425 and the fourth assembly part 438 are coupled, a discharge passage through which the refrigerant discharged from the cylinder 330 flows toward the discharge pipe 130 is formed inside the third and fourth assembly parts 425 and 438.

Thus, the third and fourth assembly parts 425 and 438 may be collectively referred to as a “main muffler”.

Here, the “main muffler” refers to a muffler with the largest volume among the plurality of discharge muffler members included in the reciprocating compressor according to the present disclosure.

Therefore, the suction muffler and the main muffler are spaced apart from each other on both sides of the suction/discharge tank 426 with the suction/discharge tank 426 interposed between the suction muffler and the main muffler.

In the present disclosure, the third assembly part 425 may be referred to as a “muffler body” of the main muffler, and the fourth assembly part 438 may be referred to as a “muffler cover” of the main muffler.

A plurality of partitions may be positioned in an internal space of the main muffler (425 and 438) to form the internal space of the main muffler into a plurality of damping spaces. The number of partitions may be variously changed.

In the present disclosure, the first assembly part 430 of the suction muffler includes an extension portion 430A that extends from a lower side of the suction/discharge tank 426 toward the main muffler (425 and 438) to have a wider width W2 than a width W1 of the second assembly part 420 in a left and right direction (Y-axis direction). The extension portion 430A is positioned below the suction/discharge tank 426.

In this instance, the extension portion 430A is formed by passing a virtual center line CL of the suction/discharge tank 426 and extending further toward the main muffler (425 and 438).

An internal volume of the extension portion 430A is equal to a volume of a reduced area A1 compared to the conventional suction muffler, or is greater than the volume of the reduced area A1 compared to the conventional suction muffler.

However, the internal volume of the extension portion 430A may be slightly less than the volume of the reduced area A1 compared to the conventional suction muffler.

Since the extension portion 430A is formed by passing the virtual center line CL of the suction/discharge tank 426 and extending toward the main muffler (425 and 438), the main muffler (425 and 438) has a width in which a lower width is less than an upper width.

According to the above-described configuration, the suction muffler (420, 430) has a volume that is increased by the volume of the extension portion 430A, compared to when the extension portion 430A is not provided.

In addition, a volume of the main muffler (425 and 438) is reduced as much as the volume of the extension portion 430A, compared to when the extension portion 430A is not provided.

Therefore, in order to secure more volume as much as the reduction in the volume of the main muffler (425 and 438), the discharge muffler member according to the present disclosure further includes a sub-muffler.

In the present embodiment, at least one sub-muffler may be provided. Considering a reduction of the discharge pulsation and an increase of the cooling capacity, etc., the following description is given of a case in which at least two sub-mufflers are provided.

In the present embodiment, the sub-muffler includes a first sub-muffler 460A connected to the main muffler (425 and 438) by the discharge hose 800, and a second sub-muffler 460B connected to the first sub-muffler 460A by the discharge hose 800.

In this instance, volumes of the main muffler (425 and 438), the first sub-muffler 460A, and the second sub-muffler 460B may be variously formed so as to reduce discharge pulsation noise of a specific frequency.

For example, the volume of the main muffler (425 and 438) may be greater than the volume of the first sub-muffler 460A and the volume of the second sub-muffler 460B, and the volume of the first sub-muffler 460A may be greater than the volume of the second sub-muffler 460B.

In this instance, the volume of the first sub-muffler 460A may be less than or equal to 50% of the volume of the main muffler (425 and 438), and the volume of the second sub-muffler 460B may be less than or equal to 50% of the volume of the first sub-muffler 460A.

The first sub-muffler 460A and the second sub-muffler 460B may be formed separately from the discharge hose 800 and may be coupled to the discharge hose 800.

In this case, each of the first sub-muffler 460A and the second sub-muffler 460B may be formed in a cylindrical shape.

In addition, the second sub-muffler 460B may be directly coupled to the discharge pipe 130 by a connector (not shown) without being couped to the discharge hose 800.

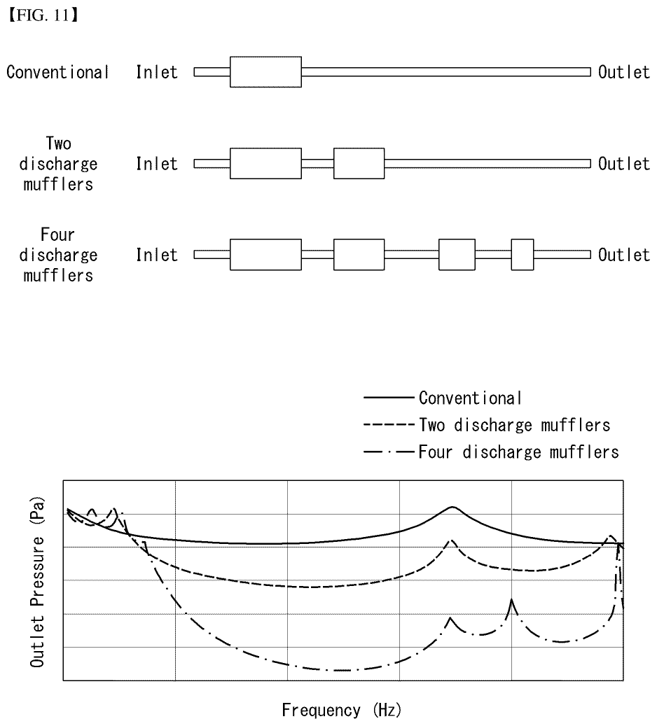

However, at least one of the first sub-muffler 460A and the second sub-muffler 460B may be formed by extending a diameter of a portion of the discharge hose 800 as illustrated in FIG. 11.

The first sub-muffler 460A and the second sub-muffler 460B may be connected in series to the main muffler (425 and 438), but the first sub-muffler 460A and the second sub-muffler 460B may be connected in parallel to the main muffler (425 and 438).

In this case, the first sub-muffler 460A and the second sub-muffler 460B may be connected in parallel to the main muffler (425 and 438) by different discharge hoses 800, and then may be coupled to a connector included in the discharge hoses 800.

According to the present embodiment, the main muffler (425 and 438), the first sub-muffler 460A, and the second sub-muffler 460B form a discharge muffler.

A sum of the volume of the first sub-muffler 460A and the volume of the second sub-muffler 460B may be greater than or equal to the volume reduced by the extension portion 430A of the suction muffler.

The refrigerant (or discharge gas) that sequentially passes through the main muffler (425 and 438) and the first and second sub-mufflers 460A and 460B is transferred to the discharge pipe 130.

It is preferable that the discharge hose 800 is formed of a flexible material, but this is not essential.

A portion of the discharge hose 800 may be supported by a hose fixing part 553. The hose fixing part 553 is coupled to the rear damper 550 and is configured to clamp the discharge hose 800.

For example, the hose fixing part 553 may have a tong shape and may surround at least a portion of an outer perimeter surface of the discharge hose 800. By the hose fixing part 553, the discharge hose 800 may be guided to be positioned in a state of being spaced apart from an inner surface of the hermetic container 100.

The discharge pipe 130 may pass through the lower hermetic container 110 and extend to the inside of the lower hermetic container 110. The discharge pipe 130 may be directly coupled to the second sub-muffler 460B, or may be connected to the discharge hose 800 coupled to the second sub-muffler 460B.

In order to facilitate the connection between the discharge pipe 130 and the discharge hose 800, the discharge pipe 130 may pass through the lower hermetic container 110, be bent, and extend upward.

The discharge hose 800 may be formed of a flexible rubber material, and the discharge pipe 130 may be formed of a metal material, for example, copper (Cu).

According to above-described configuration, the suction muffler includes the extension portion, and the discharge muffler includes the main muffler which is positioned adjacent to the suction muffler and has a volume reduced as much as the volume of the extension portion, and the first and second sub-mufflers capable of forming a volume equal to the reduced volume of the main muffler.

Accordingly, the reciprocating compressor can be (micro)miniaturized without reducing the volumes of the suction muffler and the discharge muffler compared to the conventional one.

Even if an operating speed is increased to improve an insufficient cooling capacity due to the (micro)miniaturization of the compressor, the discharge pulsation can be effectively reduced, and thus the cooling capacity can be prevented from deteriorating.

In other words, the cooling capacity can be increased in proportion to the increase in the operating speed of the compressor.

In addition, since the discharge muffler can be variously formed along a discharge path of a discharge gas, an empty space of the hermetic container can be utilized to the maximum extent, and discharge pulsation noise of a specific frequency can be reduced.

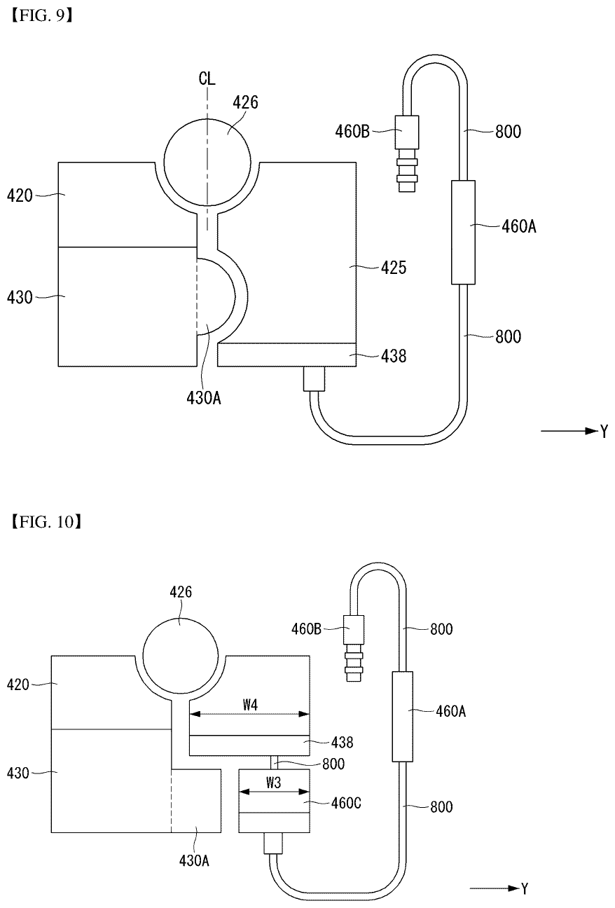

FIG. 8 schematically illustrates a connection of a muffler assembly and a discharge hose according to another embodiment of the present disclosure. FIG. 9 schematically illustrates a connection of a muffler assembly and a discharge hose according to another embodiment of the present disclosure.

In describing the present embodiment, the same or similar components as those in the embodiment described above are given the same reference numerals, and a detailed description thereof is omitted.

In the above-described embodiment, the reciprocating compressor in which the extension portion 430A of the suction muffler has a uniform width in the upward and downward direction has been described.

However, an extension portion 430A of a suction muffler may be formed in a shape in which a width increases as it goes downward, as illustrated in FIG. 8, or may be formed in a shape in which a width increases and decreases again as it goes downward, as illustrated in FIG. 9.

As above, the extension portion 430A may be formed in various shapes.

FIG. 10 schematically illustrates a connection of a muffler assembly and a discharge hose according to another embodiment of the present disclosure.

In the above-described embodiments, the reciprocating compressor including the main muffler (425 and 438) in which a width of a lower part is less than a width of an upper part due to the extension portion 430A of the suction muffler has been described.

However, a reciprocating compressor according to the present embodiment includes a main muffler (425 and 438) formed in the substantially same shape as the conventional discharge muffler and further includes a third sub-muffler 460C positioned adjacent to an extension portion 430A at a lower side of the main muffler (425 and 438), in addition to a first sub-muffler 460A and a second sub-muffler 460B.

That is, the reciprocating compressor according to the present embodiment can be understood as being formed by dividing the main muffler of the above-described embodiment into two.

The third sub-muffler 460C is connected to the main muffler (425 and 438) by a discharge hose 800 and is also connected to the first sub-muffler 460A by the discharge hose 800.

In a left and right direction (Y-axis direction), a width W3 of the third sub-muffler 460C may be less than a width W4 of the main muffler (425 and 438).

A volume of the main muffler (425 and 438) may be greater than a volume of the third sub-muffler 460C, the volume of the third sub-muffler 460C may be greater than a volume of the first sub-muffler 460A, and the volume of the first sub-muffler 460A may be greater than a volume of the second sub-muffler 460B.

In this instance, the volume of the third sub-muffler 460C may be less than or equal to 50% of the volume of the main muffler (425 and 438), the volume of the first sub-muffler 460A may be less than or equal to 50% of the volume of the third sub-muffler 460C, and the volume of the second sub-muffler 460B may be less than or equal to 50% of the volume of the first sub-muffler 460A.

The first sub-muffler 460A, the second sub-muffler 460B, and the third sub-muffler 460C may be sequentially connected in series to the main muffler (425 and 438) by the discharge hose 800. However, at least two of the first sub-muffler 460A, the second sub-muffler 460B, and the third sub-muffler 460C may be connected in parallel to the main muffler (425 and 438).

In this case, the first sub-muffler 460A and the second sub-muffler 460B may be connected in parallel to the third sub-muffler 460C by different discharge hoses 800.

In addition, the first sub-muffler 460A and the third sub-muffler 460C may be connected in parallel to the main muffler (425 and 438) by different discharge hoses 800.

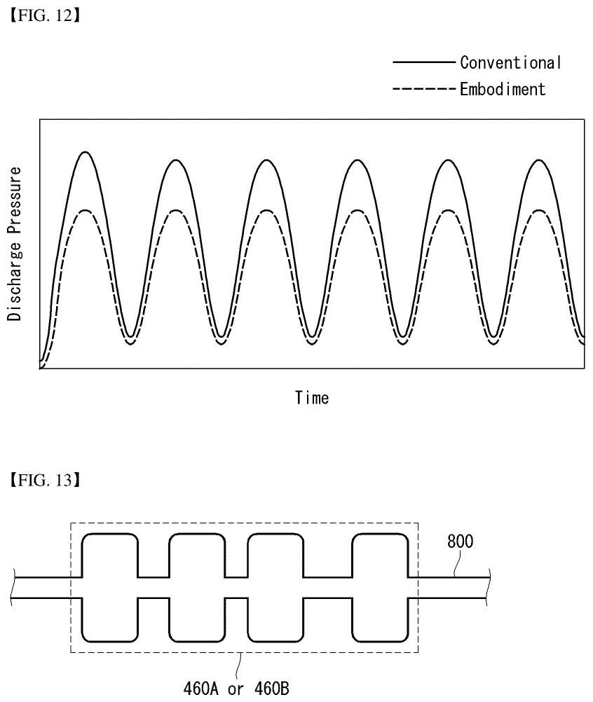

FIG. 11 is a graph illustrating changes in an outlet pressure depending on the number of discharge muffler members of a reciprocating compressor. FIG. 12 is a graph illustrating an improvement effect of discharge pulsation of a reciprocating compressor including a muffler assembly illustrated in FIG. 10.

In the graph of FIG. 11, an outlet pressure when there are two discharge mufflers and an outlet pressure when there are four discharge mufflers are compared to an outlet pressure in the conventional reciprocating compressor including only one discharge muffler. The embodiment in which the four discharge mufflers are used corresponds to the embodiment of FIG. 10.

In the graph of FIG. 12, an outlet pressure when there are four discharge mufflers is compared to an outlet pressure in the conventional reciprocating compressor including only one discharge muffler. The embodiment in which the four discharge mufflers are used corresponds to the embodiment of FIG. 10.

Referring to FIGS. 11 and 12, as described above, when multiple discharge mufflers, in which the discharge muffler is divided into a plurality of parts, for example, three or more parts or four or more parts, are formed, the outlet pressure and the discharge pressure can each be reduced compared to the conventional reciprocating compressor including only one discharge muffler.

Accordingly, the discharge pulsation can be improved.

The discharge hose 800 may be double-shot molded together with the discharge muffler. When one muffler, for example, the main muffler (425 and 438) is formed by two components, the first assembly part and the second assembly part may be coupled by laser welding.

An inlet and an outlet of the discharge muffler do not necessarily need to be aligned.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

1. A reciprocating compressor comprising:
a hermetic container forming a sealed space;
a discharge pipe coupled to the hermetic container;
a motor including a stator and a rotor, the motor being installed in the hermetic container to generate a rotational force;
a compression unit including a connecting rod that converts the rotational force of the motor into a linear drive force, a piston connected to the connecting rod, and a cylinder into which the piston is movably inserted, the compression unit being configured to compress a refrigerant; and
a suction/discharge unit including a suction muffler, a discharge muffler, and a suction/discharge tank including a suction space into which the refrigerant passing through the suction muffler is introduced and a discharge space into which the refrigerant compressed by the compression unit is introduced,
wherein the discharge muffler includes a plurality of discharge muffler members including a main muffler that is positioned on an opposite side of the suction muffler with the suction/discharge tank in between, and a sub-muffler that is spaced apart from the main muffler and is connected to the main muffler by a discharge hose, and
wherein the suction muffler includes an extension portion that extends from a lower side of the suction/discharge tank toward the main muffler.

2. The reciprocating compressor of claim 1, wherein a volume of the main muffler is greater than a volume of the sub-muffler.

3. The reciprocating compressor of claim 1, wherein the sub-muffler includes a first sub-muffler connected to the main muffler by the discharge hose and a second sub-muffler connected to the first sub-muffler by the discharge hose.

4. The reciprocating compressor of claim 3, wherein a volume of the main muffler is greater than each of a volume of the first sub-muffler and a volume of the second sub-muffler.

5. The reciprocating compressor of claim 4, wherein the volume of the first sub-muffler is greater than the volume of the second sub-muffler.

6. The reciprocating compressor of claim 4, wherein the volume of the first sub-muffler is less than or equal to 50% of the volume of the main muffler, and
wherein the volume of the second sub-muffler is less than or equal to 50% of the volume of the first sub-muffler.

7. The reciprocating compressor of claim 4, wherein at least one of the first sub-muffler and the second sub-muffler is formed by extending a diameter of a portion of the discharge hose.

8. The reciprocating compressor of claim 4, wherein each of the first sub-muffler and the second sub-muffler is formed in a cylindrical shape.

9. The reciprocating compressor of claim 4, wherein the second sub-muffler is directly coupled to the discharge pipe.

10. The reciprocating compressor of claim 3, wherein the at least two sub-mufflers further include a third sub-muffler positioned between the main muffler and the first sub-muffler.

11. The reciprocating compressor of claim 10, wherein the third sub-muffler is positioned adjacent to the extension portion of the suction muffler at a lower side of the main muffler, is connected to the main muffler by the discharge hose, and is connected to the first sub-muffler by the discharge hose.

12. The reciprocating compressor of claim 11, wherein a width of the third sub-muffler is less than a width of the main muffler.

13. The reciprocating compressor of claim 11, wherein the volume of the main muffler is greater than a volume of the third sub-muffler.

14. The reciprocating compressor of claim 13, wherein the volume of the third sub-muffler is greater than the volume of the first sub-muffler.

15. The reciprocating compressor of claim 14, wherein the volume of the third sub-muffler is less than or equal to 50% of the volume of the main muffler,
wherein the volume of the first sub-muffler is less than or equal to 50% of the volume of the third sub-muffler, and
wherein the volume of the second sub-muffler is less than or equal to 50% of the volume of the first sub-muffler.
